(19) United States
(12) Patent Application Publication
(10) Pub. No.: US 2026/0110398 A1
(43) Pub. Date: Apr. 23, 2026

(54) LEASH-MOUNTABLE CLIP ASSEMBLY

(71) Applicant: Koopa, LLC, Glencoe, MO (US)

(72) Inventor: Michael Reed Drbul, Glencoe, MO (US)

(73) Assignee: Koopa, LLC, Glencoe, MO (US)

(21) Appl. No.: 19/361,850

(22) Filed: Oct. 17, 2025

Related U.S. Application Data
(60) Provisional application No. 63/708,442, filed on Oct. 17, 2024.

(51) Int. Cl. F16M 13/02; A01K 27/00; B65F 1/00

(52) U.S. Cl. CPC F16M 13/022; A01K 27/004; B65F 1/0006; B65F 2210/18; B65F 2240/136

(57) ABSTRACT

A leash-mountable clip assembly comprises a clip rotatably connected to a disk via a swivel member. The clip assembly is configured to be adhered to a leash at the disk, such that the clip rotates relative to the leash. The clip assembly is configured to hold waste bags. A system for assembling the leash-mountable clip assembly comprises a base and a flare tool having an eyelet flare tip. The flare tool defines a tool opening for receiving a portion of the clip during use. A method of assembly involves positioning components on the base and using the flare tool to create the rotatable connection between the disk and the clip.

### CROSS-REFERENCE TO RELATED APPLICATIONS

This application claims priority to U.S. Provisional Ser. No. 63/708,442, titled “Goodwaste Bag Clip for Retractable Leash and System for Assembly”, filed Oct. 17, 2024, which is hereby incorporated by reference in its entirety.

### FIELD OF INVENTION

The present disclosure relates to pet leash accessories, and more particularly to a leash-mountable clip assembly for holding waste bags.

### BACKGROUND

Pet owners face practical challenges when walking their pets, including managing waste bags. Traditionally, pet owners carry waste bags by hand for the duration of their walk, which can be inconvenient and unsanitary. This creates an unpleasant experience that may discourage some pet owners from properly cleaning up after their pets.

Various approaches have been developed to address this problem by securing waste bags to pet leashes. Existing solutions sometimes fail to adequately control the movement of attached waste bags during walking. As the pet owner walks, the natural pendulum motion of their arm can cause attached waste bags to swing excessively. This excessive swinging can result in the waste bag swinging over the top of the leash line, becoming entangled, or making unwanted contact with the user's hand or body. These outcomes are undesirable as they can interfere with normal leash operation and create an unpleasant user experience.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a leash-mountable clip assembly is provided. The clip assembly includes a clip having a first clip member and a second clip member configured to pivot about a hinge axis between an open configuration and a closed configuration. At least one of the first and second clip members defines a swivel aperture. The clip assembly further includes a disk configured to be mounted to a leash and defining a disk opening. A swivel member extends through the swivel aperture and the disk opening along a swivel axis. The swivel member forms a rotatable connection between the disk and the clip.

According to another aspect of the present disclosure, a retractable pet leash is provided. The retractable pet leash includes a housing and a spring-biased reel in the housing. A leash is wound around the reel and has at least a portion thereof extending from the housing. The retractable pet leash further includes a disk mounted on the housing, the disk having an inner surface and an outer surface, wherein the inner surface of the disk is secured to the housing. A clip having a first clip member and a second clip member is rotatably connected to the outer surface of the disk at one of the first clip member and second clip member.

According to another aspect of the present disclosure, a system for assembling a leash-mountable clip assembly is provided. The system includes a base defining a disk receival space at an upper face thereof. The disk receival space is configured for receiving a disk of the leash-mountable clip. The upper face has an upwardly extending base post located centrally within the disk receival space. The system further includes a flare tool having an eyelet flare tip at a first end region thereof. The eyelet flare tip has a generally conical geometry and is configured for flaring an eyelet.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 shows a clip-assembly according to an embodiment, the clip assembly being mounted to a leash.

FIG. 2 is a perspective view of the clip assembly.

FIG. 3 is a side elevation of the clip assembly.

FIG. 4 is a front elevation of the clip assembly.

FIG. 5 is a cross section of a disk of the clip assembly taken in the plane 2-2 of FIG. 2

FIG. 6 is a perspective view of a base for use in assembling the clip assembly.

FIG. 7 is a perspective view of a flare tool for use in assembling the clip assembly.

FIG. 8 is an exploded view of the clip assembly over the base.

FIG. 9 shows the clip assembly being assembled using the base and the flare tool.

FIG. 10 is a flow chart for a method of manufacture of the clip assembly.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

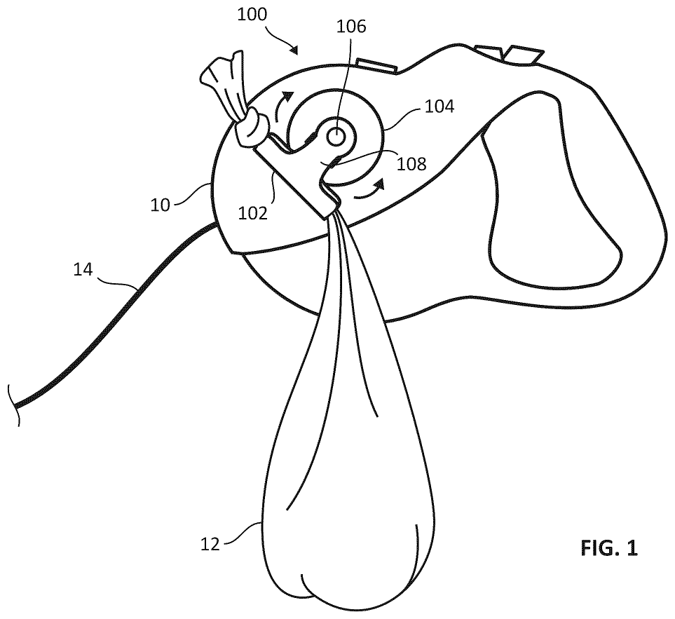

Referring to FIG. 1, the clip assembly 100 comprises a clip 102, a disk 104, and a swivel member 106 connecting the clip to the disk. The illustrated clip assembly 100 is shown mounted to a leash 10 at an operating position thereof, the clip assembly holding a waste bag 12. The leash 10 in the illustrated embodiment is a retractable leash (e.g., including a spring-biased reel for retracting the leash line 14), however the clip assembly 100 may be used with other leashes. The clip assembly 100 secures the waste bag 12 to the leash 10 while permitting rotation of the clip 102 to minimize unwanted swinging of the bag during use. The clip 102 includes clip members 108 pivotable between open and closed configurations to securely hold the waste bag 12. The disk 104 is configured to mount the clip 102 to the leash 10 and includes an adhesive surface for this purpose. The swivel member 106 extends through both the disk 104 and the clip 102, creating a rotatable connection for enabling the clip to rotate relative to the leash 10 about a swivel axis SA. This prevents excessive swaying that could cause the bag 12 to swing over the leash line 14 or make unwanted contact with the user's hand or body (not shown). The clip assembly 100 thereby provides hands-free transportation of the waste bag 12 while maintaining user comfort and preventing interference with normal leash operation.

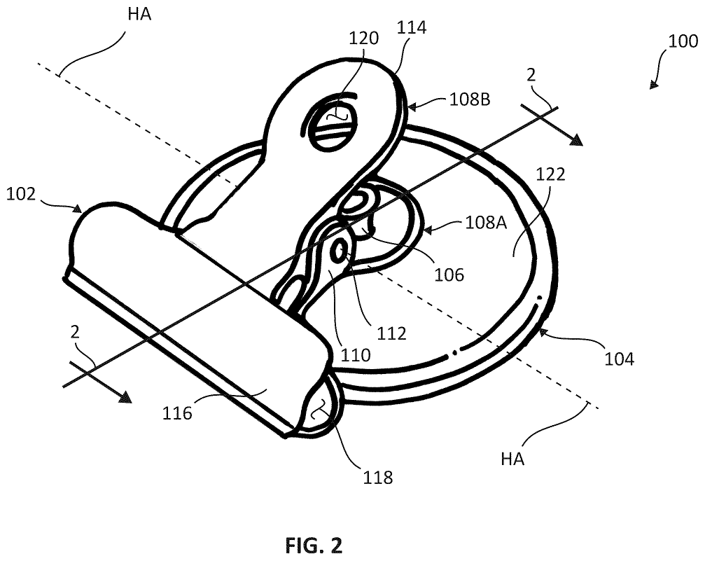

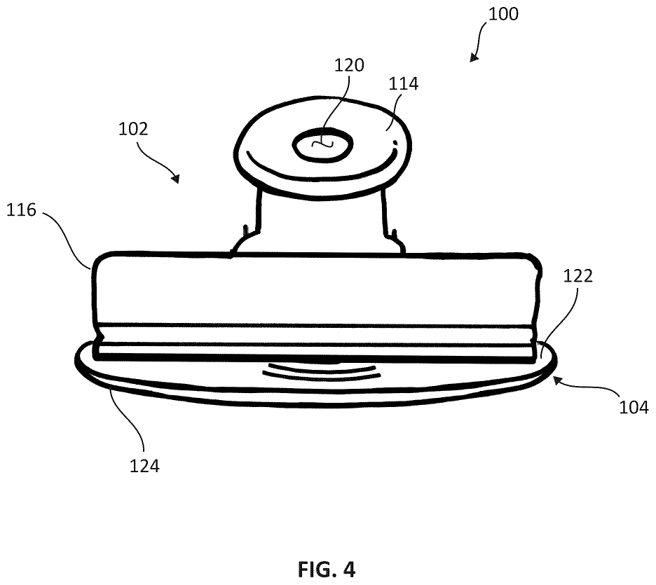

Referring to FIGS. 2-4, the clip assembly 100 is depicted in greater detail and is shown removed from the leash 10. The clip members 108 are substantially symmetrical in construction. Specifically, the clip 102 includes an inner clip member 108A which connects to the disk 104 and an outer clip member 108B which is moved (e.g., by the user) relative to the inner clip member to open or close the clip. Each clip member 108 includes hinge arms 110 that extend inwardly with respect to the overall clip 102 structure. The hinge arms 110 define hinge openings 111 positioned in registration with one another along a hinge axis HA when the clip members 108 are assembled together. A hinge pin 112 extends through the aligned hinge openings 111 along the hinge axis to hingedly connect the clip members 108; the hinge pin 112 is the pivot point about which the clip members 108 rotate relative to each other.

Each clip member 108 further includes a handle portion 114 and a holder portion 116 positioned on opposite sides of the respective hinge arms 110. The clip 102 is moved from its closed configuration to its open configuration by pressing the handle portions 114 inwardly toward each other; because the inner clip member 108A is fixed with respect to the hinge axis HA, this may be accomplished via pressure application to the outer clip member 108B alone. A spring (not shown) biases the clip 102 toward the closed configuration, such that the clip 102 can hold the bag 12 independently. When at the closed configuration, the holder portions 116 of the clip members 108 contact one another to define a holding space 118 therebetween that is configured to receive and securely retain the waste bag 12. In an embodiment, the clip members 108 are biased in a default closed configuration wherein the holder portions 116 are biased together.

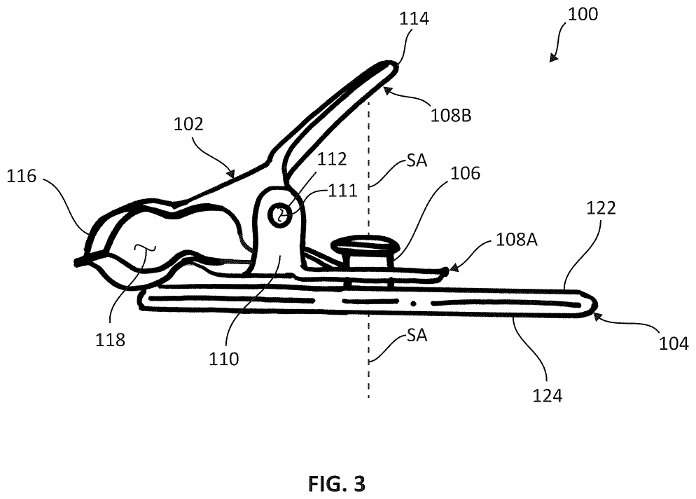

The holder portions 116 are configured with a generally arcuate geometry (see FIG. 3) that extends laterally outward from their respective clip members 108. Thus, the resulting holding space 118 has a substantially cylindrical geometry. A cylindrical holding space 118 may be advantageous for securing waste bags that have been tied off with a closure knot, as the holder portions 116 are dimensioned to engage the waste bag at a location below the closure knot, such that the knot prevents the bag from slipping through the clip 102. This is shown at FIG. 1. In alternative aspects, the holder portions 116 may be configured with different geometries for providing alternative retention mechanisms. For example, the holder portions 116 may be substantially flat (e.g., defining no holding space 118) and configured to retain waste bags primarily through frictional engagement rather than mechanical interference with a knot.

At least the inner clip member 108A defines a swivel aperture 120 at the handle 114 thereof. The swivel aperture 120 is configured to receive the swivel member 106, and is thus similarly sized.

The disk 104 serves as the mounting interface between the clip 102 and the leash 10 while enabling rotational movement of the clip relative to the leash. The disk 104 includes an outer surface 122 configured to interface with the clip 102 and an inner surface 124 configured for attachment to the leash 10. The adhesive is applied to the inner surface 124 to facilitate permanent bonding of the disk 104 to the leash's 10 surface (e.g., at a housing of the leash). This may be complemented by an adhesive cover (not shown) configured to be peeled therefrom, promoting easy installation onto the leash 10 (e.g., when received by a customer, the user). The outer surface 122 may also be referred to as a distal surface relative to the housing of leash 10 and the inner surface 124 may also be referred to as a proximal surface relative to the housing of leash 10.

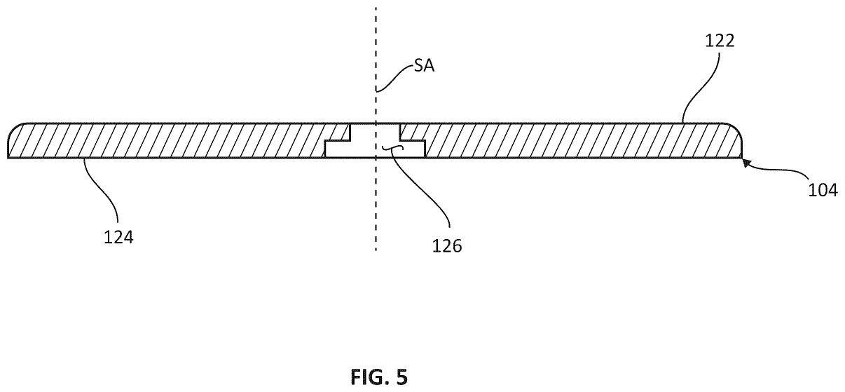

The disk 104 defines a disk opening 126 that extends therethrough and which is configured to receive the swivel member 106. The disk opening 126 is visible at FIG. 5. The disk opening 126 includes a counterbore that allows the swivel member 106 to be recessed within the disk 104. The counterbore ensures that the swivel member 106 does not protrude from the inner surface 124 of the disk 104, thereby preventing interference with the bond between the disk and the leash 10.

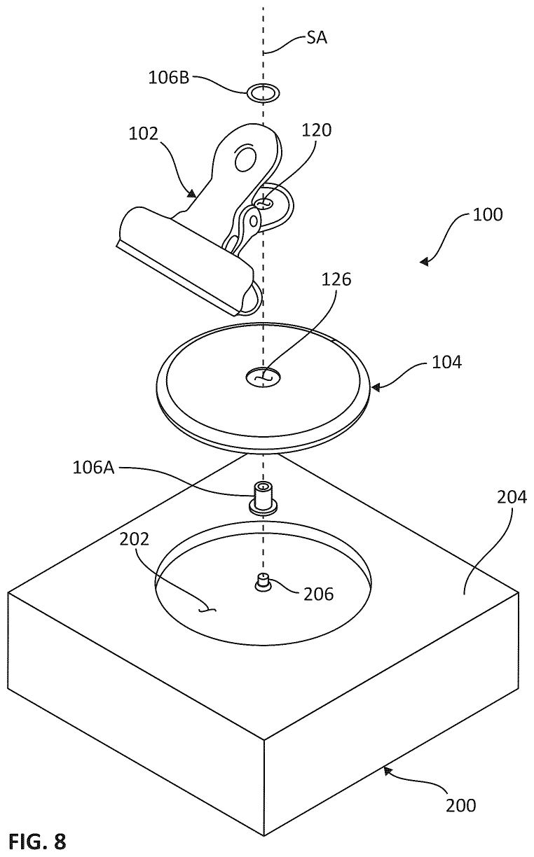

The swivel member 106 establishes the rotatable connection between the clip 102 and the disk 104, and generally comprises an eyelet 106A and a washer 106B. The eyelet 106A and washer 106B are combined to form a unitary swivel member 106 during manufacture such that a secure but rotatable connection is formed between the disk 104 and the clip 102. The eyelet 106A is inserted through both the disk opening 126 and the swivel aperture 120 of the inner clip member 108A. The washer 106B is positioned over the eyelet 106A to distribute loads across the connection after installation (see FIG. 8). In alternative aspects, other swivel members 106 may be used (e.g., rivets). In alternative aspects, the washer 106B may also be omitted.

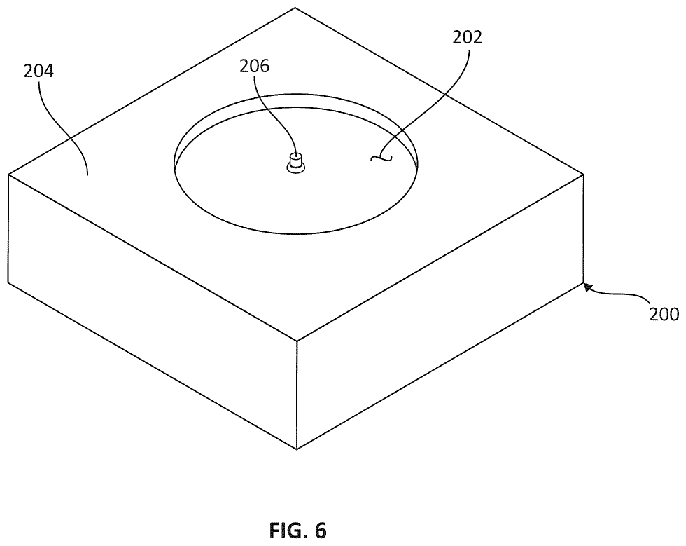

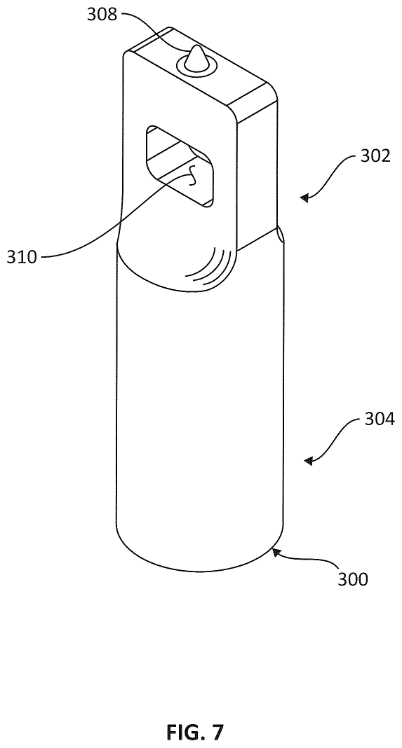

Referring to FIGS. 6-9, a system for assembling the clip assembly 100 generally comprises a base 200 and a flare tool 300.

The base 200 is configured to support and stabilize the clip assembly 100 during manufacturing thereof. The base 200 defines a disk receival space 202 at an upper face 204 thereof, with the disk receival space being dimensioned to receive the disk 104. A base post 206 extends upwardly from the upper face 204 and centrally from the disk receival space 202, and is configured to be received within the disk opening 126 during assembly. The base post 206 further aligns the disk 104 and maintains its position while the swivel member 106 is being installed. In some aspects, the disk receival space 202 has a depth that corresponds to the thickness of the disk 104, allowing the disk to sit flush with the upper face 204 of the base 200. The base post 206 height is configured to extend through the disk opening 126 without protruding beyond the outer surface 122 of the disk 104.

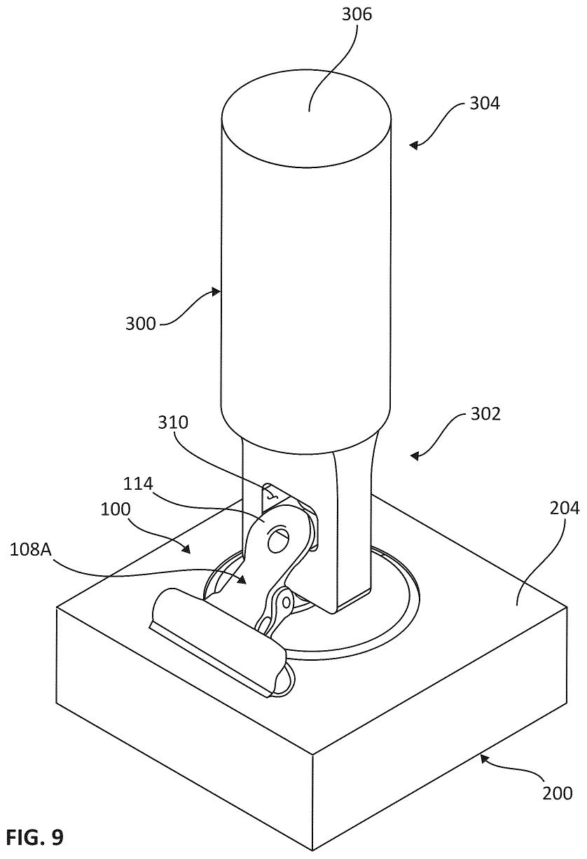

The flare tool 300 is configured for use by an operator to flare the eyelet 106A during manufacture of the clip assembly 100. The flare tool 300 comprises a first end region 302 and a second end region 304 spaced apart from one another along a longitudinal axis. The second end region 304 has a substantially cylindrical geometry for being held by an operator during use, and may include a textured surface for improved grip. The second end region 304 includes a substantially flat end surface 306 (see FIG. 9) configured to receive impacts from a hammer or mallet. The first end region 302 tapers inwardly from the second end region 304 to a reduced dimension and terminates in an eyelet flare tip 308 having a generally conical geometry. The eyelet flare tip 308 is shaped and sized for insertion into the eyelet 106A of the swivel member 106 to facilitate radial expansion thereof during a flaring operation (e.g., as shown at FIG. 9).

A tool opening 310 is defined laterally through the first end region 302, with the tool opening being configured to receive a portion of the outer clip member 108B during assembly. The tool opening 310 has a generally rectangular cross-section that is dimensioned to accommodate the outer clip member 108B while providing clearance for the flaring operation. This tool opening 310 permits the flare tool 300 to be positioned directly upright over the eyelet 106A during the assembly process, rather than requiring oblique positioning that would otherwise be necessitated by interference from the outer clip member 108B; without the tool opening 310, the outer clip member 108B would block direct access to the eyelet 106A, making it difficult to achieve proper flaring and potentially compromising the quality of the assembled connection.

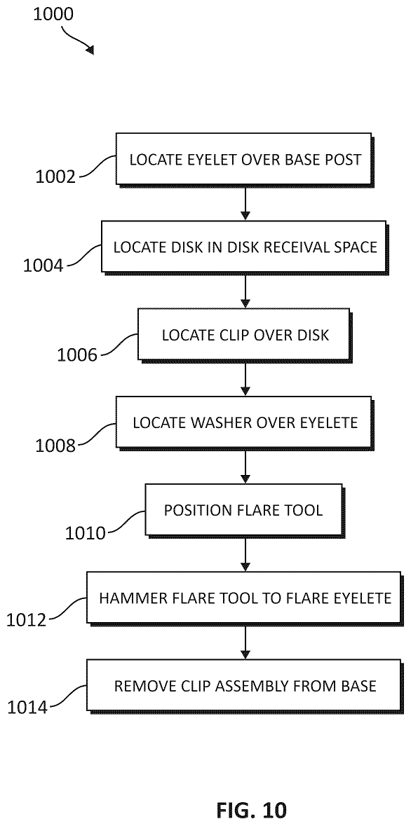

Referring to FIG. 10, a method 1000 of assembly for the clip assembly 100 is shown in the form of a flow chart, and will now be described.

Assembly of the clip assembly 100 begins at operation 1002 by placing the eyelet 106A over the base post 206 of the base 200. The eyelet 106A is positioned such that its cylindrical body slides down over the base post 206, with the base post extending upwardly through a central opening of the eyelet.

At operation 1004, the disk 104 is placed within the disk receival space 202 of the base 200. As the disk 104 is positioned, the base post 206 and eyelet 106A extend upwardly through the disk opening 126. In the illustrated embodiment, the disk 104 includes an adhesive cover (e.g., a peel) for preventing the disk 104 from bonding to the base 200. In alternative aspects, the adhesive may be added after assembly of the clip assembly 100.

At operation 1006, the clip 102 is positioned over the disk 104. The swivel aperture 120 of the inner clip member 108A is aligned with the disk opening 126, allowing the eyelet 106A to pass therethrough. This creates the initial connection between the clip 102 and disk 104 components, though the connection remains loose at this stage to permit positioning adjustments.

At operation 1008, the washer 106B is placed over the portion of the eyelet 106A extending upwardly beyond the swivel aperture 120 of the inner clip member 108A. The washer 106B is a load distribution component, and may be positioned to rest against the handle portion 114 of the inner clip member 108A. This prepares the assembly for the flaring operation that will secure the clip 102 to the disk 104.

At operation 1010, the flare tool 300 is positioned directly over the eyelet 106A in preparation for the flaring operation. The outer clip member 108B is received within the tool opening 310 of the flare tool 300, allowing the tool 300 to be positioned vertically above the eyelet 106A without interference. The eyelet flare tip 308 of the tool 300 is inserted into the central opening of the eyelet 106A. This is generally depicted at FIG. 9.

At operation 1012, a flaring operation is performed by striking the flat end surface of the flare tool 300 with a hammer or mallet. The force of the strikes are transmitted through the tool 300 to the eyelet flare tip 308, forcing the eyelet 106A to expand radially outward. This radial expansion creates a permanent mechanical connection between the clip 102 and disk 104 while maintaining the rotatable interface that permits swivel motion of the clip relative to the disk.

At operation 1014, the completed clip assembly 100 is removed from the base 200. The assembled unit now comprises the clip 102 rotatably connected to the disk 104 via the flared swivel member 106, ready for installation on a leash 10. The base 200 and flare tool 300 may then be used for subsequent assembly operations of additional clip assemblies 100.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of embodiments of the present disclosure, and describes several embodiments, adaptations, variations, alternatives and uses of the aspects of the embodiments, including what is presently believed to be the best mode of carrying out the aspects of the embodiments. Additionally, it is to be understood that the aspects of the embodiments are not limited in its application to the details of construction and the arrangement of components set forth in the following description or illustrated in the drawings. The aspects of the embodiments are capable of alternative embodiments and of being practiced or carried out in various ways. Also, it will be understood that the phraseology and terminology used herein is for the purpose of description and should not be regarded as limiting.

It will be apparent that modifications and variations are possible without departing from the scope of the embodiments defined in the appended claims. As various changes could be made in the above constructions and methods without departing from the scope of the present disclosure, it is intended that all matter contained in the above description and shown in the accompanying drawings shall be interpreted as illustrative and not in a limiting sense.

In view of the above, it will be seen that several advantages of the aspects of the present disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A leash-mountable clip assembly, comprising:
a clip including a first clip member and a second clip member configured to hinge about a hinge axis between an open configuration and a closed configuration, at least one of the first and second clip members defining a swivel aperture;
a disk configured to be mounted to a leash and defining a disk opening;
a swivel member extending through the swivel aperture and the disk opening along a swivel axis, the swivel member forming a rotatable connection between the disk and the clip.

2. The leash-mountable clip assembly of claim 1, further comprising an adhesive on an inner surface of the disk for bonding the disk to the leash.

3. The leash-mountable clip assembly of claim 2, wherein the disk opening comprises a counterbore, and wherein the swivel member is recessed within the counterbore.

4. The leash-mountable clip assembly of claim 3, further comprising the leash, wherein the disk is fixedly adhered to the leash via the adhesive such that the clip is rotatable relative to the leash.

5. The leash-mountable clip assembly of claim 4, wherein the leash is configured to be held at an operating position when being operated by a user, and wherein the swivel axis is substantially horizontal when the leash is held at the operating position.

6. The leash-mountable clip assembly of claim 5, wherein the first clip member includes a first holder and the second clip member includes a second holder, wherein the first and second holders are configured to hold a bag when the clip is at the closed configuration.

7. The leash-mountable clip assembly of claim 6, wherein the bag is a waste bag configured for holding pet waste, and wherein the clip assembly is configured to permit pendular motion of the bag in registration with pendular motion of the leash as the user walks.

8. The leash-mountable clip assembly of claim 1, wherein the swivel member comprises an eyelet and a washer.

9. The leash-mountable clip assembly of claim 1, wherein the clip is a bulldog style clip.

10. A retractable pet leash, comprising:
a housing;
a spring-biased reel in the housing;
a leash line wound around the reel and having at least a portion thereof extending from the housing;
a disk mounted on the housing, the disk having an inner surface and an outer surface, wherein the inner surface of the disk is secured to housing;
a clip having a first clip member and a second clip member, the clip being rotatably connected to the outer surface of the disk at one of the first clip member and second clip member.

11-19. (canceled)

20. A method of assembling a leash-mountable clip assembly, comprising:
placing an eyelet over a base post of a base;
placing a disk within a disk receival space of the base, wherein the base post and eyelet extend upwardly through a disk opening of the disk;
positioning a clip over the disk such that the eyelet passes through a swivel aperture of the clip;
positioning a flare tool directly over the eyelet, wherein a portion of the clip is received within a tool opening of the flare tool; and
performing a flaring operation by pressing the flare tool to cause the eyelet to expand radially outward and form a rotatable connection between the clip and the disk.

21. The retractable pet leash of claim 10, further comprising a swivel member, wherein the clip defines a swivel aperture, wherein the disk defines a disk opening, and wherein the swivel member extends through the swivel aperture and the disk opening along a swivel axis, the swivel member forming a rotatable connection between the disk and the clip.

22. The retractable pet leash of claim 21, further comprising an adhesive on the inner surface of the disk for securing the disk to the housing.

23. The retractable pet leash of claim 22, wherein the disk opening comprises a counterbore, and wherein the swivel member is recessed within the counterbore.

24. The retractable pet leash of claim 23, wherein the disk is fixedly adhered to the housing via the adhesive such that the clip is rotatable relative to the housing.

25. The retractable pet leash of claim 24, wherein the retractable pet leash is configured to be held at an operating position when being operated by a user, and wherein the swivel axis is substantially horizontal when the retractable pet leash is held at the operating position.

26. The retractable pet leash of claim 25, wherein the first clip member includes a first holder and the second clip member includes a second holder, wherein the first and second holders are configured to hold a bag when the clip is at a closed configuration.

27. The retractable pet leash of claim 26, wherein the bag is a waste bag configured for holding pet waste, and wherein the clip is configured to permit pendular motion of the bag in registration with pendular motion of the retractable pet leash as the user walks.

28. The retractable pet leash of claim 21, wherein the swivel member comprises an eyelet and a washer.

29. The retractable pet leash of claim 21, wherein the clip is a bulldog style clip.
